(19) United States
(12) Patent Application Publication
(10) Pub. No.: US 2019/0075935 A1
(43) Pub. Date: Mar. 14, 2019

(54) BASSINET WITH ELECTROMAGNETIC DRIVE

(71) Applicant: Delta Enterprise Corp., New York, NY (US)

(72) Inventors: Carlos Ng, New York, NY (US); Scott A. Lewis, New York, NY (US); Sam L. Shamie, New York, NY (US)

(21) Appl. No.: 15/701,940

(22) Filed: Sep. 12, 2017

(51) Int. Cl. A47D 9/02; H02K 7/14

(52) U.S. Cl. CPC A47D 9/02; H02K 7/14

(57) ABSTRACT

A bassinet includes a base, a bassinet frame including a mattress support, a guiding assembly for supporting the bassinet frame on the base for movement in a reciprocal manner along a reciprocal path such that the mattress support is maintained parallel to a ground surface on which the base is supported, and a drive arrangement for driving the bassinet frame in the reciprocal manner along the reciprocal path, the drive arrangement including an electromagnetic pulse generator mounted to the base for generating spaced apart electromagnetic pulses of predetermined intensities, and two spaced apart permanent magnets mounted to the mattress support, with a center line of the electromagnetic pulse generator being offset from a central line between the permanent magnets in an initial position of the bassinet frame.

### BACKGROUND OF THE INVENTION

The present invention relates generally to bassinets, and more particularly, is directed to a bassinet that rocks or glides back and forth.

Bassinets that provide a rocking motion are well known. However, with such bassinets, the rocking motion occurs over a curved arcuate path such that the inclination of the mattress support changes during the rocking motion. Specifically, such bassinets provide a curved base, similar to that of a rocking chair, by which the bassinet can be rocked back and forth to lull the baby to sleep.

However, because of this arcuate rocking motion, the baby is tossed side to side, that is, the baby may turn from his or her back to his or side. Depending on the extent of the arc, this could also result in the baby turning over onto his or her stomach.

Further, in such prior rocking bassinets, the child may roll to one side of the bassinet, which prevents further rocking of the bassinet and may cause the child to wedge against the side wall of the bassinet.

Still further, conventional bassinets are moved back and forth by a motor assembly which includes mechanical moving parts. This renders the bassinet more complicated and costly, and subject to breakdown of the mechanical moving parts, as well as increasing the noise, which can be disruptive of an infant's sleep.

### SUMMARY OF THE INVENTION

Accordingly, it is an object of the present invention to provide a bassinet that overcomes the aforementioned problems.

It is another object of the present invention to provide a bassinet that rocks or glides back and forth while maintaining the mattress support in a horizontal orientation at all times such that the sleep surface substantially always remains horizontal to the ground, rather than at an angle.

It is still another object of the present invention to provide a bassinet that is moved by an electromagnetic drive arrangement.

It is yet another object of the present invention to provide a bassinet that is easy and economical to assemble and manufacture.

In accordance with an aspect of the present invention, a bassinet includes a base, a bassinet frame including a mattress support, a guiding assembly for supporting the bassinet frame on the base for movement in a reciprocal manner along a reciprocal path such that the mattress support is maintained parallel to a ground surface on which the base is supported, and a drive arrangement for driving the bassinet frame in the reciprocal manner along the reciprocal path. The drive arrangement includes an electromagnetic pulse generator mounted to the base for generating spaced apart electromagnetic pulses of predetermined intensities, and two spaced apart permanent magnets mounted to the mattress support, wherein a center line of the electromagnetic pulse generator is offset from a central line between the permanent magnets in an initial position of the bassinet frame.

The guiding assembly includes at least one guide connected to an upper end of the base, and at least one moving member movably mounted to the at least one guide and further connected with either the bassinet frame or the mattress support.

In one embodiment, the at least one moving member includes at least one rocking member, each rocking member having one end pivotally mounted on the at least one guide and an opposite end pivotally connected to the bassinet frame. Preferably, the at least one guide includes two parallel, spaced apart rods, there are four rocking members, with two of the rocking members pivotally mounted on one rod in spaced apart relation to each other and the other two of the rocking members pivotally mounted on the other rod in spaced apart relation to each other, and the opposite end of each rocking member is pivotally connected to a lower portion of the bassinet frame.

Further, the bassinet frame includes upstanding rods, with a bracket connected to each upstanding rod for supporting the mattress support thereon.

In another embodiment, the mattress support is fixedly connected with the bassinet frame, the at least one moving member is fixedly connected with the mattress support, and the at least one moving member includes at least one gliding member, each having one end slidably mounted on the at least one guide for linear reciprocal sliding movement thereon. Preferably, the at least one guide includes two parallel, spaced apart rods, and there are four gliding members, with two of the gliding members slidably mounted on one rod in spaced apart relation to each other and the other two of the gliding members slidably mounted on the other rod in spaced apart relation to each other.

The permanent magnets are positioned immediately above the electromagnetic pulse generator. Further, the electromagnetic pulse generator includes an adjustment device for adjusting at least one of the following: a time spacing between adjacent electromagnetic pulses, and an intensity of each electromagnetic pulse, in order to adjust the extent of movement of the bassinet frame in the reciprocal manner along the reciprocal path.

The bassinet frame includes a plurality of upstanding rods and an upper support frame connected to upper ends of the upstanding rods for supporting a bassinet liner so that a lower end of the bassinet liner rests on the mattress support, and a mattress pad is supported within the bassinet liner.

The above and other objects, features and advantages of the invention will become readily apparent from the following detailed description thereof which is to be read in connection with the accompanying drawings.

### BRIEF DESCRIPTION OF THE DRAWINGS

FIG. 1 is a front, top perspective view of a bassinet according to a first embodiment of the present invention, without the fabric secured to the upper frame; FIG. 2 is a front, top perspective view of the bassinet of FIG. 1, with the mattress support removed;

FIG. 3 is a perspective view of the bassinet frame;

FIG. 4 is a top plan view of the bassinet of FIG. 2;

FIG. 5 is a bottom plan view of the mattress support;

FIG. 6 is a side elevational view of the bassinet of FIG. 1;

FIG. 7 is an end elevational view of the bassinet of FIG. 1 in an initial position;

FIG. 8 is an end elevational view of the bassinet of FIG. 1 in a first rocking position;

FIG. 9 is an end elevational view of the bassinet of FIG. 1 in a second rocking position;

FIG. 10 is a front, top perspective view of a bassinet according to a second embodiment of the present invention, without the fabric secured to the upper frame;

FIG. 11 is a bottom plan view of the mattress support of FIG. 10, along with the guiding assembly;

FIG. 12 is a side elevational view of the bassinet of FIG. 10;

FIG. 13 is an end elevational view of the bassinet of FIG. 10 in an initial position;

FIG. 14 is an end elevational view of the bassinet of FIG. 10 in a first gliding position;

FIG. 15 is an end elevational view of the bassinet of FIG. 10 in a second gliding position; and

FIG. 16 is a schematic wiring diagram of the control circuit for the bassinet.

### DETAILED DESCRIPTION

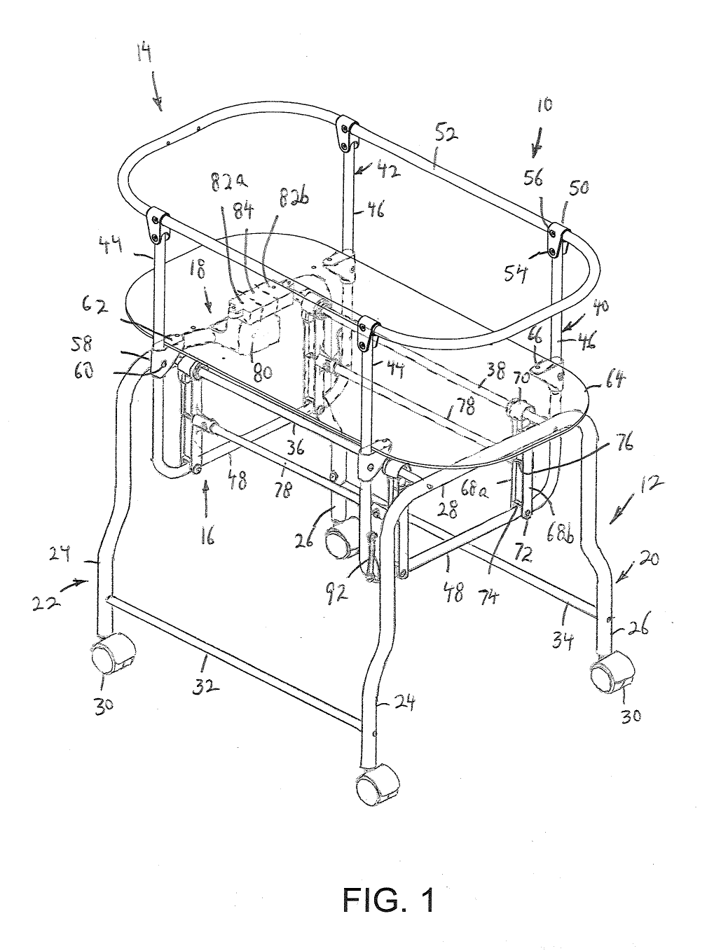

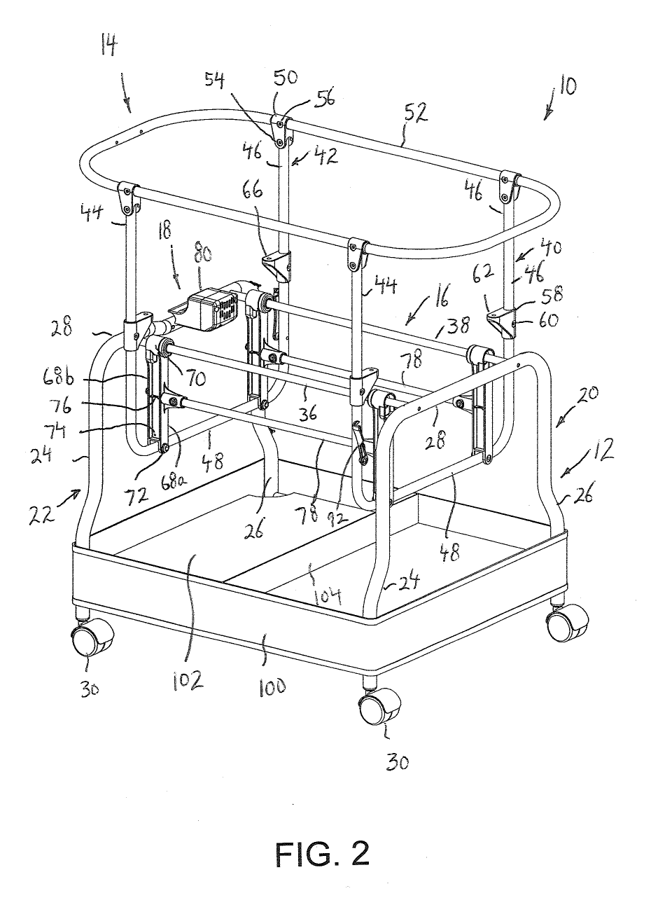

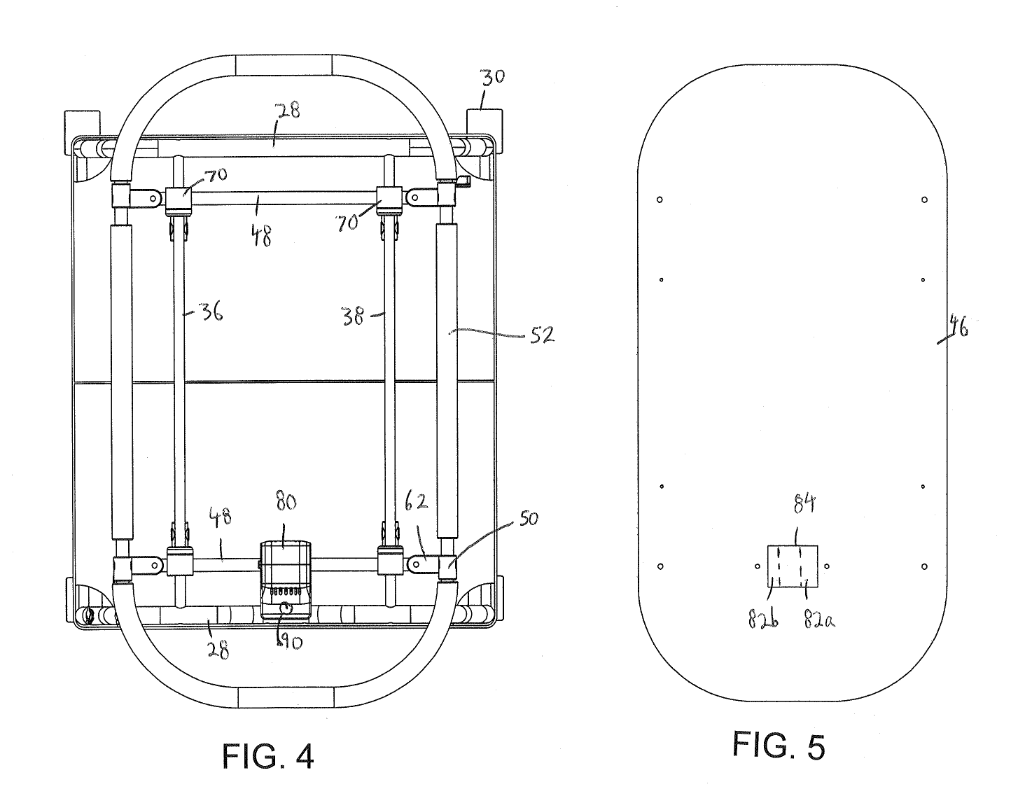

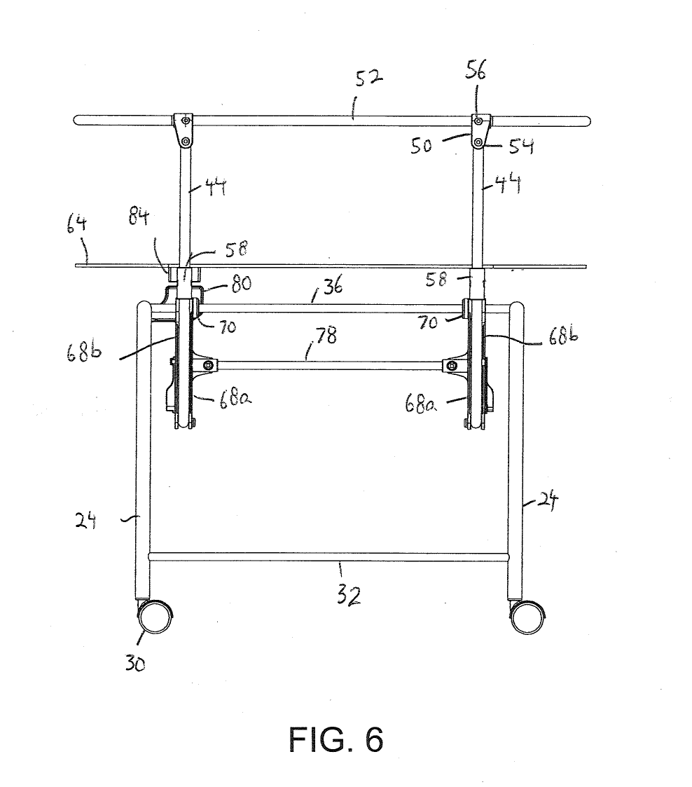

Referring to the drawings in detail, and initially to FIGS. 1-9 thereof, a bassinet 10 according to the present invention includes a base 12, a bassinet frame 14 that is supported by base 12, a guiding assembly 16 for supporting bassinet frame 14 on base 12 for movement in a linear reciprocal rocking back and forth manner, and a drive assembly 18 for moving bassinet frame 14 in said rocking manner.

Specifically, base 12 includes two spaced apart, inverted U-shaped leg supports 20, 22, each including two spaced apart vertically extending legs 24, 26 connected at their upper ends by a connecting member 28. Casters 30 are provided at the lower ends of vertically extending legs 24, 26 for supporting bassinet 10 on a surface, to permit easy movement of bassinet 10. Casters 30 can be locked in position to prevent movement during operation of bassinet 10, as is well known. In place of casters 30, rollers, wheels or the like can be provided. Alternatively, stationary feet (not shown) can be provided which sit upon a ground surface. For stability purposes, the lower ends of the legs 24 of the two leg supports 20, 22 are connected together by a connecting rod 32, and the lower ends of the legs 26 of the two leg supports 20, 22 are connected together by a connecting rod 34.

As shown best in FIG. 1, opposite ends of the two connecting members 28 of the two leg supports 20, 22 are connected together by two parallel, space apart connecting guide rods 36, 38, which also form part of guiding assembly 16.

Bassinet frame 14 includes two spaced apart, U-shaped leg supports 40, 42, each including two spaced apart vertically extending legs 44, 46 connected at their lower ends by a connecting member 48.

Inverted U-shaped brackets 50 are provided at the upper ends of vertical leg supports 40, 42 for securing an upper support frame 52 in parallel, spaced apart relation to a floor on which bassinet 10 is supported. Upper support frame 52 is preferably a closed, endless rod in an oval shape or a rectangular shape with rounded corners, although the present invention is not limited thereby. Rivets 54 or the like secure inverted U-shaped brackets 50 to the upper ends of vertical leg supports 40, 42, and rivets 56 secure inverted U-shaped brackets 50 to upper support frame 52.

A bracket 58 is secured about midway to each vertical leg support 40, 42 by bolts 60, with each bracket 58 including an extension support 62 extending inwardly of bassinet 10 for supporting a mattress support 64 thereon. Mattress support 64 is preferably a medium density fiberboard (MDF), preferably in an oval configuration or a rectangular shape with rounded corners, although the present invention is not limited thereto. In such case, mattress support 64 is secured to extension supports 62 by bolts 66.

It will be appreciated that a bassinet liner (not shown) is supported by upper support frame 52 such that a lower end of the bassinet liner rests on mattress support 64, with a mattress (not shown) supported on the bassinet liner and mattress support 64.

Guiding assembly 16 is secured between connecting members 48 in a space below brackets 58. Specifically, guiding assembly 16 includes the aforementioned connecting rods 36, 38 which connect together the two connecting members 28 of the two leg supports 20, 22.

Guiding assembly 16 further includes four sets of two parallel, spaced apart elongated inner and outer rocking plates 68a, 68b, connected between connecting rods 36, 38 and connecting members 48 in order to support bassinet frame 14 on base 12 in a rocking manner, while maintaining mattress support 64 in a horizontal orientation at all times such that the sleep surface substantially always remains horizontal to the ground, rather than at an angle. Specifically, a bushing 70 connected to the upper ends of each pair of inner and outer rocking plates 68a, 68b, is rotatably mounted to a respective connecting rod 36, 38 at a position below a respective bracket 58. One elongated rocking plate 68a extends downwardly from each bushing 70 such that the lower end of the elongated rocking plate 68a is positioned to one side of a respective connecting member 48. The other elongated rocking plate 68b extends downwardly from each bushing 70 in parallel, spaced relation from elongated rocking plate 68a, such that the lower end of the elongated rocking plate 68b is positioned to the opposite side of the respective connecting member 48. A pivot rivet 72 extends through the lower end of each elongated rocking plate 68a, the respective connecting member 48 and the lower end of the respective elongated rocking plate 68b, to pivotally secure the lower ends of elongated rocking plates 68a, 68b to the respective connecting member 48.

To provide increased stability, a cross member 74 is connected between the lower ends of each pair of elongated rocking plates 68a, 68b, immediately above connecting member 48, and a cross member 76 is connected between each pair of elongated rocking plates 68a, 68b, at midpoints thereof. To further provide stability, two connecting rods 78 are provided, with each end thereof connected to midpoints of inner elongated rocking plates 68a.

With this arrangement, as bushings 70 rotate about connecting rods 34, 36, elongated rocking plates 68a, 68b pivot back and forth. As a result, bassinet frame 14 also pivots back and forth therewith. However, because of this arrangement of four sets of two elongated rocking plates 68a, 68b, mattress support 64 is maintained in a horizontal orientation at all times such that the sleep surface substantially always remains horizontal to the ground, rather than at an angle, during such rocking motion.

In order to provide such rocking motion, an electromagnetic pulse generator 80 is mounted centrally to one connecting member 28 so as to be positioned below mattress support 64. Two permanent magnets 82a, 82b are mounted to the underside of mattress support 64 so as to be immediately above electromagnetic pulse generator 80. Permanent magnets 82a, 82b are provided in a housing 84, and are spaced apart from each other in a widthwise direction of mattress support 64, for example, by about two inches.

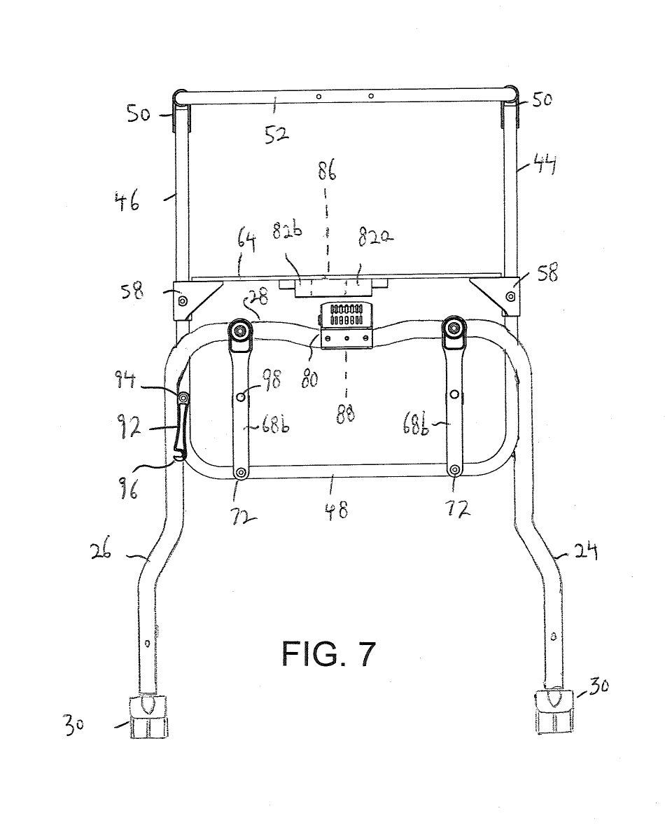

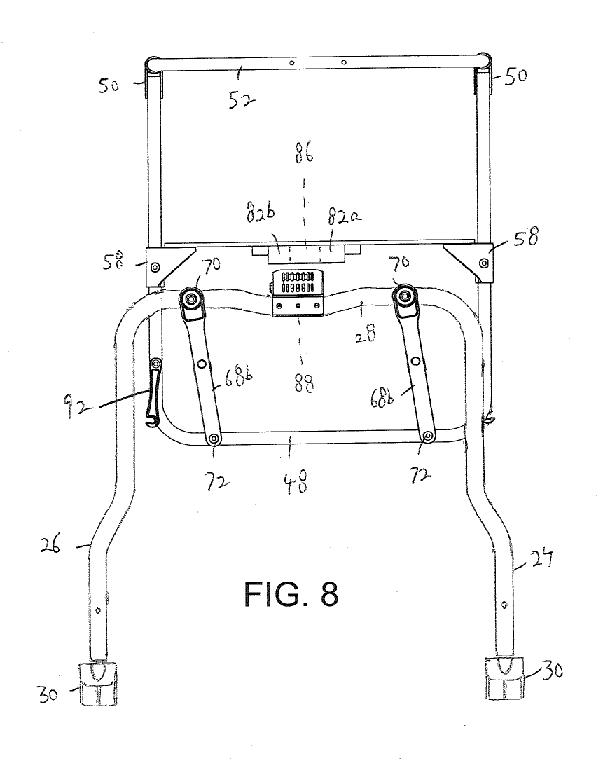

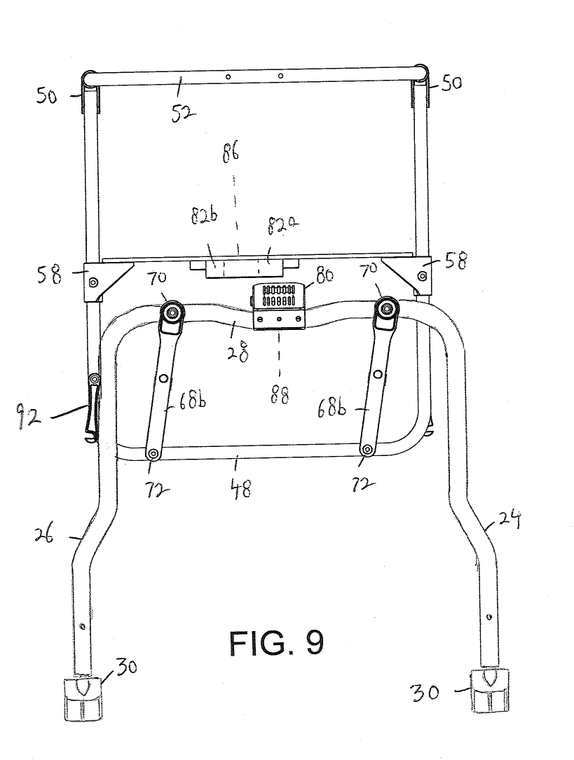

In accordance with an important aspect of the present invention, as best shown in FIG. 7, a center line 86 between permanent magnets 82a, 82b is offset from a center line 88 of electromagnetic pulse generator 80. As a result, when an initial pulse is generated by electromagnetic pulse generator 80, it will have the effect of creating a greater force on the permanent magnet 82a closer to center line 88, which functions to slightly move bassinet frame 14 in a first rotating direction, shown in FIG. 8. When bassinet frame 14 reaches its outer rotation position due to such initial pulse, it will start rotating back in the opposite direction due to gravity. At such time, electromagnetic pulse generator 80 generate a second pulse which exerts a pulling force in such direction on the permanent magnets 82a, 82b, whereby bassinet frame 14 will then rock in the opposite direction, as shown in FIG. 9. When bassinet frame 14 reaches its outer rotation position in the opposite direction due to the second pulse, it will start rotating back due to gravity. At such time, a third electromagnetic pulse is generated, and so on, whereby bassinet frame 14 will be caused to rock back and forth.

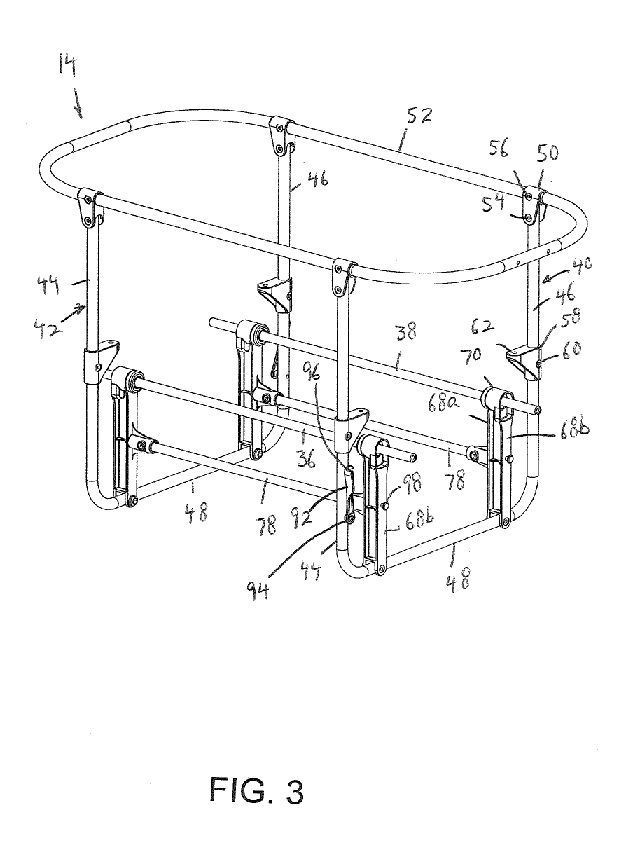

The distance traveled by bassinet frame 14 in each direction during such rocking motion will depend on the strength of the permanent magnets 82a, 82b, the strength of each electromagnetic pulse, and the timing between the electromagnetic pulses. For example, stronger electromagnetic pulses result in a greater rocking motion. In this regard, a control knob 90 (FIG. 4) is provided with electromagnetic pulse generator 80 in order to vary the strength of each electromagnetic pulse and/or the timing between the electromagnetic pulses. For example, control knob 90 can be a simple rotary knob which controls potentiometers or the like of electromagnetic pulse generator 80 to vary the strength of each electromagnetic pulse and/or the timing between the electromagnetic pulses.

Electromagnetic pulse generator 80 is preferably powered by a 120V AC power line connected to a conventional socket. However, it can also be powered by batteries.

As a result of this arrangement, unlike a motor drive assembly, which includes mechanical moving parts, the use of the electromagnetic pulse generator 80 renders the drive assembly less complicated and less expensive, subject to fewer breakdowns since there are no mechanical moving parts, as well as reducing the noise, which is more conducive to an infant's sleep.

In order to lock bassinet frame 14 in its initial position of FIG. 7, a pivoting member 92 has one end pivotally connected to a vertically extending leg 44 of U-shaped leg support 40 by a pivot pin 94, and a similar pivoting member 92 has one end pivotally connected to a vertically extending leg 46 of U-shaped leg support 42 by a pivot pin 94. The opposite free end of each pivoting member 88 includes a hook 96 which can be pivoted into engagement with a pin 98 mounted to the outer surface of the adjacent outer elongated rocking plate 68b.

It will be appreciated that various modifications can be made to the invention. For example, in place of connecting rods 32 and 34, a skirt 100 can be positioned around the lower ends of vertically extending legs 24 and 26, as shown in FIG. 2, with a bottom wall 102 connected to the lower ends of skirt 100 so as to provide a storage area beneath bassinet 10. Preferably, skirt 100 and bottom wall 102 are made from a fabric material. A divider 104 can be positioned on bottom wall 102 and connected to opposite sides of skirt 100 to divide bottom wall 102 into two separate areas.

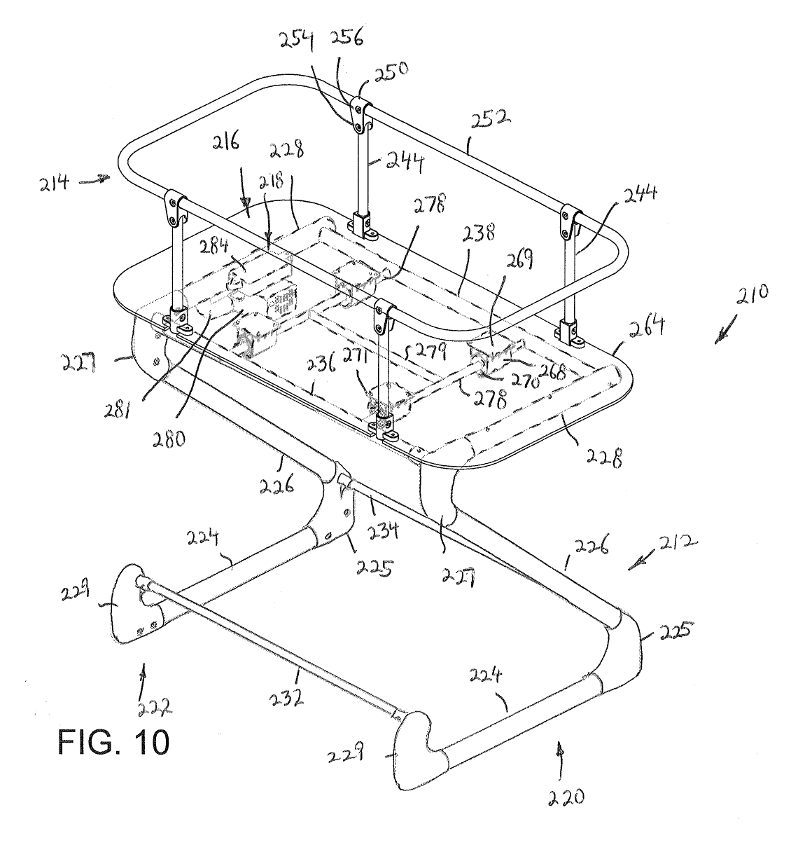

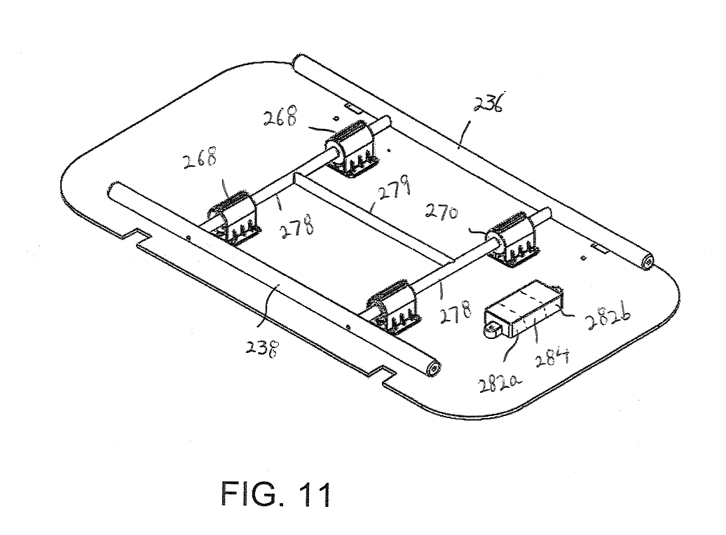

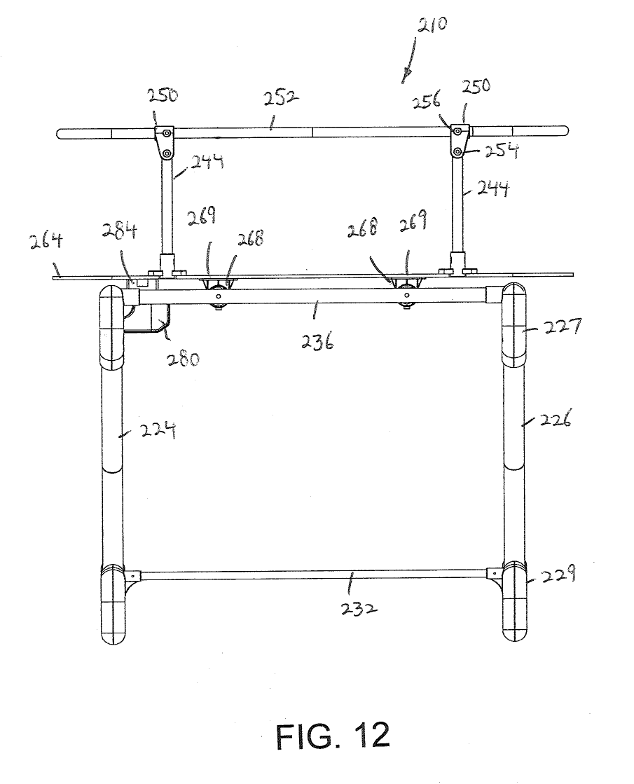

Referring now to FIGS. 10-15, a bassinet 210 according to another embodiment of the present invention will now be described. As shown, bassinet 210 includes a base 212, a bassinet frame 214 that is supported by base 212, a guiding assembly 216 for supporting bassinet frame 214 on base 112 for movement in a reciprocal linear gliding back and forth manner, and a drive assembly 218 for moving bassinet frame 214 in said gliding manner.

Specifically, base 212 includes two spaced apart, Z-shaped leg supports 220, 222, each including a lower horizontal leg 224 which lies on a ground surface, an inclined leg 226 having its lower end connected by an L-shaped connector 225 with one end of the respective horizontal leg 224 and an upper horizontal leg 228 having one end connected by an L-shaped connector 227 to the free end of inclined leg 226 so as to be positioned in parallel spaced relation from horizontal leg 224. An L-shaped connector 229 is also connected to the free end of each lower horizontal leg 224. Casters, rollers or the like can be secured to lower horizontal leg 224, if desired. L-shaped connectors 229 of leg supports 220, 222 are connected together by a connecting rod 232, and L-shaped connectors 225 of leg supports 220, 222 are connected together by a connecting rod 234.

As shown best in FIG. 10-12, opposite ends of the two upper horizontal legs 228 are connected together by two parallel, spaced apart connecting rods 236, 238, which also form part of guiding assembly 216.

Bassinet frame 214 includes four spaced apart vertically extending legs 244 connected at their lower ends to the upper surface of a mattress support 264. Mattress support 264 is preferably a medium density fiberboard (MDF), preferably in an oval configuration or a rectangular shape with rounded corners, although the present invention is not limited thereto. Inverted U-shaped brackets 250 are provided at the upper ends of vertically extending legs 244 for securing an upper support frame 252 in parallel, spaced apart relation to a floor on which bassinet 210 is supported. Upper support frame 252 is preferably a closed, endless rod in an oval shape or a rectangular shape with rounded corners, although the present invention is not limited thereby. Rivets 254 or the like secure inverted U-shaped brackets 250 to the upper ends of vertically extending legs 244, and rivets 256 secure inverted U-shaped brackets 250 to upper support frame 252.

Guiding assembly 216 is secured below mattress support 264 and between upper horizontal legs 228. Two parallel, spaced apart connecting rods 278 are each connected at opposite ends thereof to connecting rods 236, and a further connecting rod 279 is connected at opposite ends thereof to midpoints of spaced apart connecting rods 278.

Guiding assembly 216 further includes four slide members 268, each including a bushing 270 through which a connecting rod 278 extends to slidably mount slide members 268 thereon. Specifically, two slide members 268 are slidably mounted on each connecting rod 278, on opposite sides of connecting rod 279. Each slide member 268 further includes a raised upper planar surface 269 on which the lowest surface of mattress support 264 rests, and to which mattress support 264 is secured by screws 271. In this manner, bassinet frame 214 is mounted for gliding movement relative to base 212 back and forth in a linear manner, that is, in a flat plane, defined by the linear direction of connecting rods 278, without any arcuate rocking motion. Bushings 270 permit easy movement of bassinet frame 214 in this linear movement on base 212 with very little friction.

In order to control such gliding motion, an electromagnetic pulse generator 280 is mounted centrally below one upper horizontal leg 228 by a downwardly extending U-shaped connecting bar 281 so as to be positioned below mattress support 264. Two permanent magnets 282a, 282b are mounted to the underside of mattress support 264 so as to be positioned immediately above electromagnetic pulse generator 280. Permanent magnets 282a, 282b are provided in a housing 284, and are spaced apart from each other in a widthwise direction of mattress support 264, for example, by about two inches.

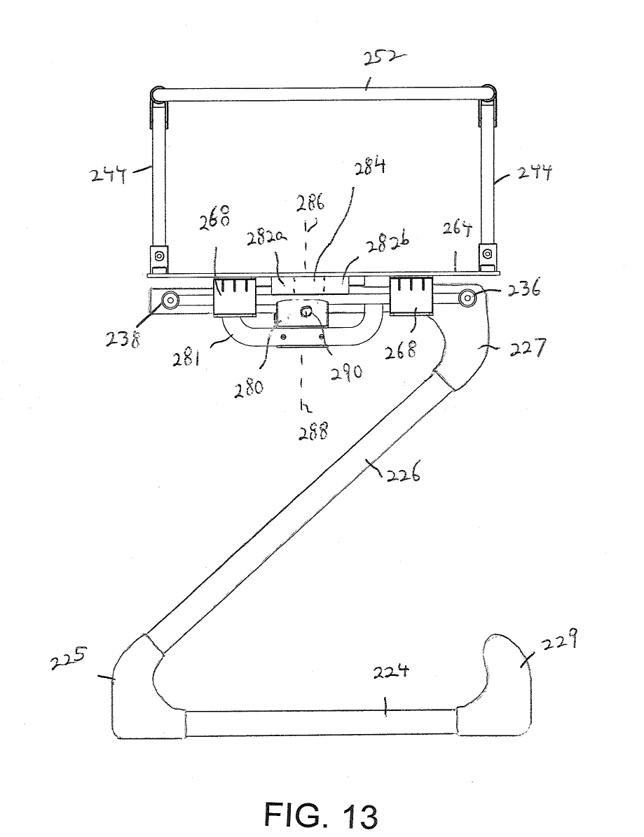

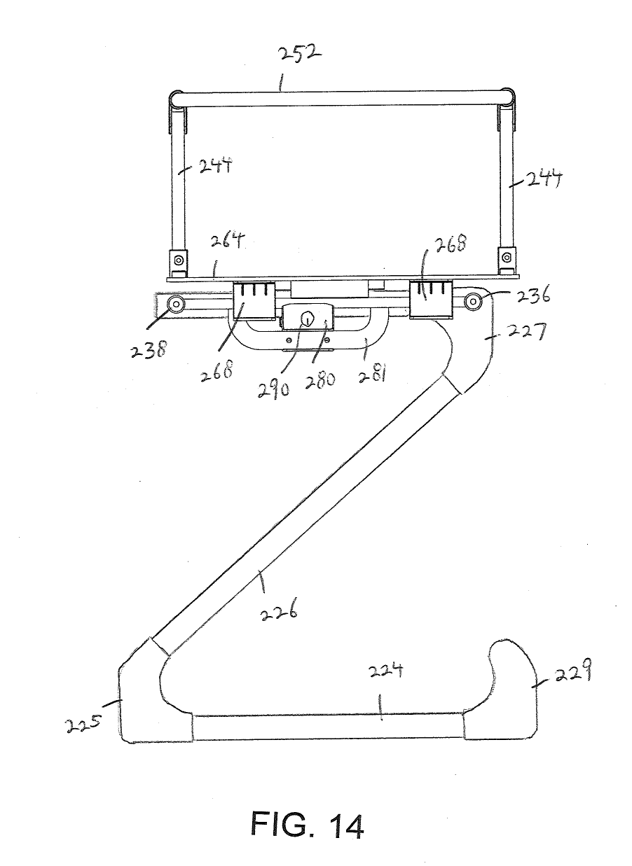

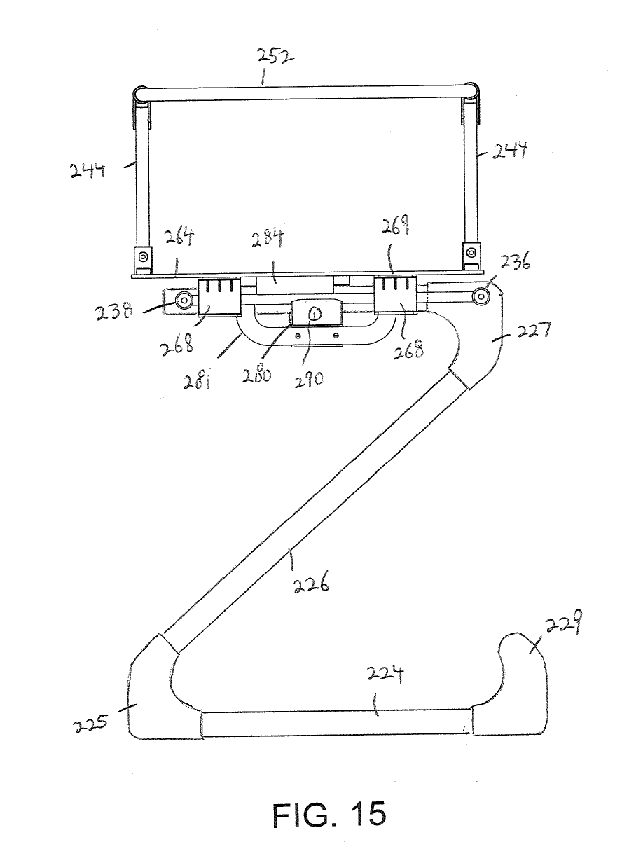

In accordance with an important aspect of the present invention, as best shown in FIG. 13, a center line 286 between permanent magnets 282a, 282b is offset from a center line 288 of electromagnetic pulse generator 280. As a result, when an initial pulse is generated by electromagnetic pulse generator 280, it will have the effect of creating a greater force on the permanent magnet 282a closer to center line 288, which functions to slightly move bassinet frame 214 in a first gliding direction, shown in FIG. 14. When bassinet frame 214 reaches its outer gliding position due to such initial pulse, electromagnetic pulse generator 280 generates a second pulse which exerts a pulling force in such direction on the permanent magnets 282a, 282b, whereby bassinet frame 214 will glide in the opposite direction, as shown in FIG. 15. This operation continues, whereby bassinet frame 214 will be caused to glide back and forth.

The distance traveled by bassinet frame 214 in each direction during such gliding motion will depend on the strength of the permanent magnets 282a, 282b, the strength of each electromagnetic pulse, and the timing between the electromagnetic pulses. For example, stronger electromagnetic pulses result in a greater gliding distance. In this regard, a control knob 290 is provided with electromagnetic pulse generator 280 in order to vary the strength of each electromagnetic pulse and/or the timing between the electromagnetic pulses. For example, control knob 290 can be a simple rotary knob which controls potentiometers or the like of electromagnetic pulse generator 280 to vary the strength of each electromagnetic pulse and/or the timing between the electromagnetic pulses.

Electromagnetic pulse generator 280 is preferably powered by a 120V AC power line connected to a conventional socket. However, it can also be powered by batteries.

As a result of this arrangement, unlike a motor drive assembly, which includes mechanical moving parts, the use of the electromagnetic pulse generator 280 renders the drive assembly less complicated and less expensive, subject to fewer breakdowns since there are no mechanical moving parts, as well as reducing the noise, which is more conducive to an infant's sleep.

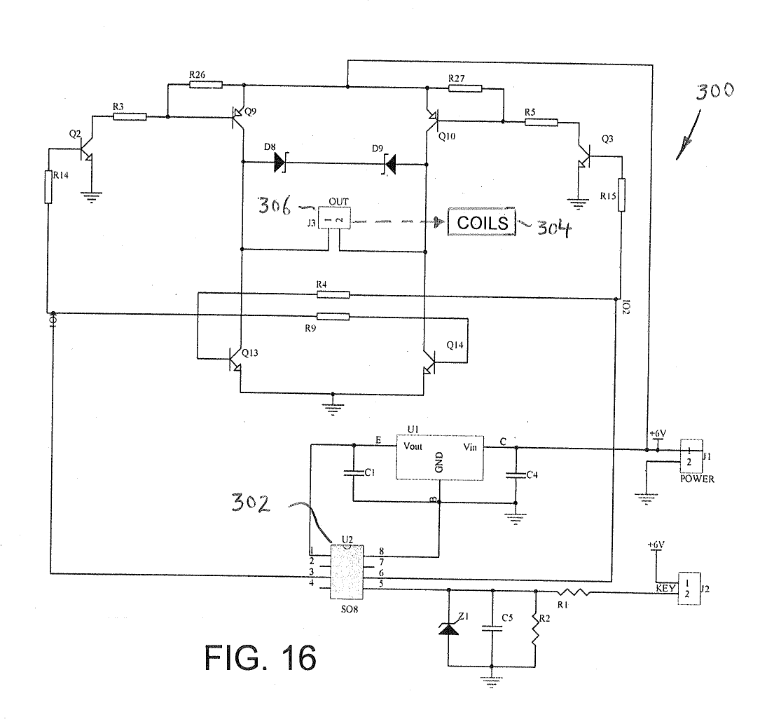

The schematic wiring diagram of the control circuit 300 for the bassinet, that is, the control circuit 300 for controlling the strength, duration and timing of the electromagnetic pulses, is shown in FIG. 16. When power is ON, the central processing unit 302 of the control circuit 300 changes the directions of the current, so that the coil will have N-poles and S-poles. The coils 304 are connected to the output 306. Preferably, the interval between pulses is 0.5 second.

Having described specific preferred embodiments of the invention with reference to the accompanying drawings, it will be appreciated that the present invention is not limited to those precise embodiments and that various changes and modifications can be effected therein by one of ordinary skill in the art without departing from the scope or spirit of the invention as defined by the appended claims.

What is claimed is:

1. A bassinet comprising:
a base,
a bassinet frame including a mattress support,
a guiding assembly for supporting said bassinet frame on said base for movement in a reciprocal manner along a reciprocal path such that said mattress support is maintained parallel to a ground surface on which said base is supported, and
a drive arrangement for driving said bassinet frame in said reciprocal manner along said reciprocal path, said drive arrangement including:
an electromagnetic pulse generator mounted to said base for generating spaced apart electromagnetic pulses of predetermined intensities, and
two spaced apart permanent magnets mounted to said mattress support,
wherein a center line of said electromagnetic pulse generator is offset from a central line between said permanent magnets in an initial position of the bassinet frame.

2. A bassinet according to claim 2, wherein said guiding assembly includes:
at least one guide connected to an upper end of said base, and
at least one moving member movably mounted to said at least one guide and further connected with one of:
said bassinet frame, and
said mattress support.

3. A bassinet according to claim 2, wherein said at least one moving member includes at least one rocking member, each rocking member having one end pivotally mounted on the at least one guide and an opposite end pivotally connected to the bassinet frame.

4. A bassinet according to claim 4, wherein:
the at least one guide includes two parallel, spaced apart rods,
there are four said rocking members, with two of said rocking members pivotally mounted on one rod in spaced apart relation to each other and the other two of said rocking members pivotally mounted on the other rod in spaced apart relation to each other, and
the opposite end of each rocking member is pivotally connected to a lower portion of the bassinet frame.

5. A bassinet according to claim 4, wherein the bassinet frame includes upstanding rods, with a bracket connected to each upstanding rod for supporting the mattress support thereon.

6. A bassinet according to claim 2, wherein:
said mattress support is fixedly connected with said bassinet frame,
said at least one moving member is fixedly connected with said mattress support, and
said at least one moving member includes at least one gliding member, each having one end slidably mounted on the at least one guide for linear reciprocal sliding movement thereon.

7. A bassinet according to claim 6, wherein:
the at least one guide includes two parallel, spaced apart rods, and
there are four said gliding members, with two of said gliding members slidably mounted on one rod in spaced apart relation to each other and the other two of said gliding members slidably mounted on the other rod in spaced apart relation to each other.

8. A bassinet according to claim 1, wherein said permanent magnets are positioned immediately above the said electromagnetic pulse generator.

9. A bassinet according to claim 1, wherein said electromagnetic pulse generator includes an adjustment device for adjusting at least one of:
a time spacing between adjacent electromagnetic pulses, and
an intensity of each electromagnetic pulse, in order to adjust the extent of movement of said bassinet frame in said reciprocal manner along said reciprocal path.

10. A bassinet according to claim 1, wherein said bassinet frame includes a plurality of upstanding rods and an upper support frame connected to upper ends of said upstanding rods for supporting a bassinet liner so that a lower end of said bassinet liner rests on said mattress support, and a mattress pad is supported within said bassinet liner.
